(19) United States
(12) Patent Application Publication
(10) Pub. No.: US 2023/0005468 A1
(43) Pub. Date: Jan. 5, 2023

(54) POSE ESTIMATION MODEL LEARNING APPARATUS, POSE ESTIMATION APPARATUS, METHODS AND PROGRAMS FOR THE SAME

(71) Applicant: NIPPON TELEGRAPH AND TELEPHONE CORPORATION, Tokyo (JP)

(72) Inventors: Mizuki NAGANO, Tokyo (JP); Yusuke IJIMA, Tokyo (JP); Nozomi KOBAYASHI, Tokyo (JP)

(73) Assignee: NIPPON TELEGRAPH AND TELEPHONE CORPORATION, Tokyo (JP)

(21) Appl. No.: 17/779,518

(22) PCT Filed: Nov. 26, 2019
(86) PCT No.: PCT/JP2019/046148

§ 371 Date: May 24, 2022

(51) Int. Cl. G10L 13/10; G06F 40/268; G10L 13/047; G10L 13/06

(52) U.S. Cl. CPC G10L 13/10; G06F 40/268; G10L 13/047; G10L 13/06

(57) ABSTRACT

A pause estimation model learning apparatus includes: a morphological analysis unit configured to perform morphological analysis on training text data to provide M types of information, M being an integer that is equal to or larger than 2; a feature selection unit configured to combine N pieces of information, among the M pieces of information, to be an input feature when a predetermined certain condition is satisfied, and select predetermined one of the N pieces of information to be the input feature when the certain condition is not satisfied, N being an integer that is equal to or larger than 2 and equal to or smaller than M; and a learning unit configured to learn a pause estimation model by using the input feature selected by the feature selection unit and a pause correct label.

### TECHNICAL FIELD

The present disclosure relates to a pause estimation model learning apparatus that learns a pause estimation model for estimating a timing of putting an intermission (hereinafter, also referred to as “pause”) for implementing speech synthesis, a pause estimation apparatus that uses the pause estimation model to estimate a pause position, a method for these, and a program.

### BACKGROUND ART

When a text is read using synthesized speech, processing is executed to estimate a timing of putting an intermission in a sentence.

When this processing is executed using a pause estimation model learned by machine learning such as Conditional random field (CRF) or Deep Neural Network (DNN), training data for the pause estimation model requires data as a result of morphologically analyzed a huge amount of text data and a pause correct label indicating a pause position in the text data read. Generally, the writing, part-of-speech, conjugation, and the like of a morpheme from the morphologically analyzed data are used as input features (feature amount) for the learning (see NPL 1).

### CITATION LIST

### Non Patent Literature

NPL 1: Masayuki Suzuki, Ryo Kuroiwa, Keisuke Innami, Shumpei Kobayashi, Shinya Shimizu, Nobuaki Minematsu, and Keikichi Hirose, “Accent Sandhi Estimation of Tokyo Dialect of Japanese Using Conditional Random Fields”, IEICE Transactions, Vol. J 96— D, No. 3, pp. 644-654, 2013

### SUMMARY OF THE INVENTION

### Technical Problem

Various features of morphemes, such as writing, part-of-speech, and conjugation, can be used for the learning. However, an increase in the number of features in an attempt to increase the coverage leads to a higher cost for creating training data. Furthermore, the increased features are not necessarily effective for the pause estimation.

In particular, when the writing is used as one of the features, morphemes with different writings are regarded as different features, giving rise to a complex combination between features leading to a larger model size, resulting in a problem in that the used amount of a read only memory (ROM) or a random access memory (RAM) is increased and the execution speed is compromised.

Patterns in which a pause is inserted into a sentence are limited. In view of this, the estimation is desirably performed with the smallest possible calculation amount using some features effective for the estimation, instead of thoughtlessly using a large number of features.

An object of the present disclosure is to provide a pause estimation model learning apparatus, a method thereof, and a program with which the model size of the pause estimation model can be reduced and the learning processing speed can be improved, without compromising the accuracy of estimation of a pause in a sentence.

### Means for Solving the Problem

In order to solve the above problem, according to one aspect of the present disclosure, a pause estimation model learning apparatus includes: a morphological analysis unit configured to perform morphological analysis on training text data to provide M types of information, M being an integer that is equal to or larger than 2; a feature selection unit configured to combine N pieces of information, among the M pieces of information, to be an input feature when a predetermined certain condition is satisfied, and select predetermined one of the N pieces of information to be the input feature when the certain condition is not satisfied, N being an integer that is equal to or larger than 2 and equal to or smaller than M; and a learning unit configured to learn a pause estimation model by using the input feature selected by the feature selection unit and a pause correct label.

### Effects of the Invention

The present disclosure provides an effect that the model size of the pause estimation model can be reduced and the learning processing speed can be improved, without compromising the accuracy of estimation of a pause in a sentence.

### BRIEF DESCRIPTION OF DRAWINGS

FIG. 1 is a diagram illustrating an example of input features of a related-art method.

FIG. 2 is a diagram illustrating an example of input features of a first embodiment.

FIG. 3 is a diagram illustrating an example of an overall configuration of speech synthesis processing.

FIG. 4 is a functional block diagram of a pause estimation model learning apparatus according to the first embodiment.

FIG. 5 is a flowchart of an example of processing flow of the pause estimation model learning apparatus according to the first embodiment.

FIG. 6 is a diagram illustrating an example of a configuration in which four types of information “writing”, “part-of-speech”, “conjugation”, and “reading” are given to a morpheme.

FIG. 7 is a diagram illustrating an example of a part of the training text data divided into morphemes, input features of related art, and input features of the present embodiment.

FIG. 8 is a diagram illustrating an example of a combination between features.

FIG. 9 is a diagram illustrating an example of a combination between features.

FIG. 10 is a diagram illustrating an example of a combination between features.

FIG. 11 is a diagram illustrating an example of a combination between features.

FIG. 12 is a diagram illustrating features used in an experiment.

FIG. 13 is a diagram illustrating sizes of models according to a related-art method and according to the present embodiment, and accuracy of pause estimation relative to the same test data.

FIG. 14 is a functional block diagram of a pause estimation model learning apparatus according to a second embodiment.

FIG. 15 is a flowchart of an example of processing flow of the pause estimation model learning apparatus according to the second embodiment.

FIG. 16 is a functional block diagram of a pause estimation apparatus according to a third embodiment.

FIG. 17 is a flowchart of an example of processing flow of the pause estimation apparatus according to the third embodiment.

FIG. 18 is a diagram illustrating a configuration example of a computer to which the present method is applied.

### DESCRIPTION OF EMBODIMENTS

Hereinafter, embodiments of the present disclosure will be described. In the drawings used in the following description, the same reference signs are given to components having the same function or the steps of performing the same processing, and duplicate description is omitted. Furthermore, in the following description, it is assumed that processing performed for each element of a vector or a matrix is applied to all elements of the vector or the matrix unless otherwise specified.

### Points of First Embodiment

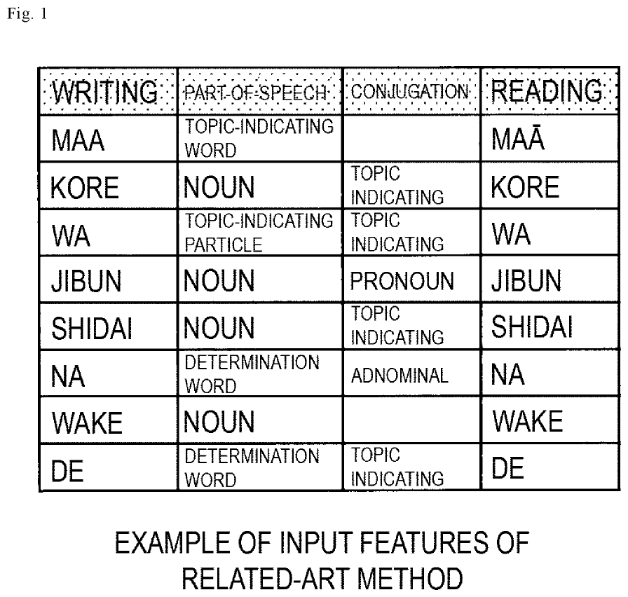

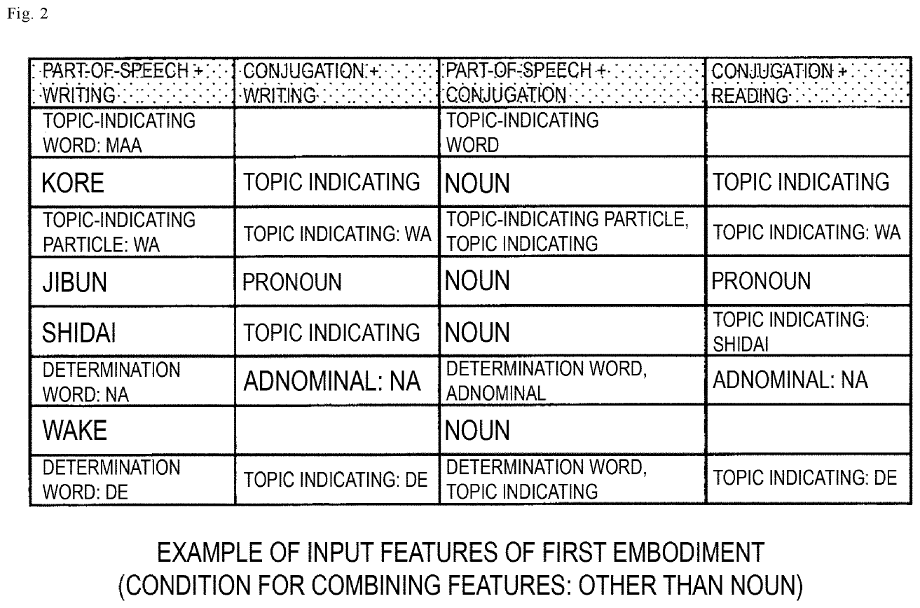

The training data for the pause estimation model in the speech synthesis requires the data as a result of morphological analysis on a huge amount of text data and the pause correct label. Of these, the morphologically analyzed data is used as the input features, for learning the pause estimation model by machine learning. Here, the present embodiment is mainly different from related-art methods in the following points. Specifically, in the related art, information, such as the part-of-speech and writing obtained by the morphological analysis (see FIG. 1), is directly used for as the input features for the learning. On the other hand, in the present embodiment, such information is not directly used, and features are combined under a certain condition designated in advance, to be used as the input feature (see FIG. 2). With this configuration, the features with a huge amount of information can be locally used, without the combinations among the features being complex.

In the present embodiment, the amount of training data can be reduced, with the features combined under a certain condition to narrow down the features for selecting input features effective for the pause estimation. Furthermore, the model size can be reduced and processing speed can be improved without compromising pause estimation accuracy.

### First Embodiment

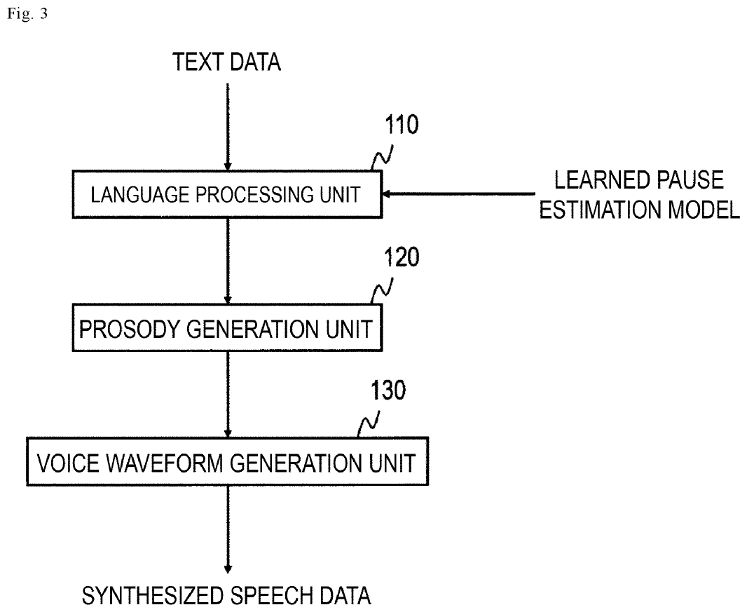

FIG. 3 illustrates an example of an overall configuration of speech synthesis processing.

Conversion of text data into synthesized speech is performed through processing roughly divided into three stages of processes respectively executed by a language processing unit 110, a prosody generation unit 120, and a voice waveform generation unit 130.

First of all, the language processing unit 110 receives the text data as input, analyzes the input text data, provides information such as how the text is read, with what accent, and where the pause is put, and outputs the information as a context of a synthesized text.

Next, the prosody generation unit 120 receives the context of the synthesized text as an input, provides information such as intonation, inflection, and rhythm of sound, and outputs the information as a voice parameter.

Finally, the voice waveform generation unit 130 receives the voice parameter as an input, and generates a voice waveform from the voice parameter, and outputs the voice waveform as synthesized speech data.

In the present embodiment, of the above processes, a focus is given on a pause estimation process executed by the language processing unit 110.

If the pause estimation process is executed by machine learning, a pause estimation model needs to be learned. In this process, with a related-art method, a feature selection unit selects a part of features obtained by morphological analysis, to be directly used as the input feature. In the present embodiment, the features are selected, and then are combined with other features under a certain condition designated in advance, to be used as the input feature. The processes thereafter can be performed through a procedure similar to that in the related-art method.

Pause estimation model learning apparatus according to first embodiment In the present embodiment, an apparatus learning a pause estimation model will be described.

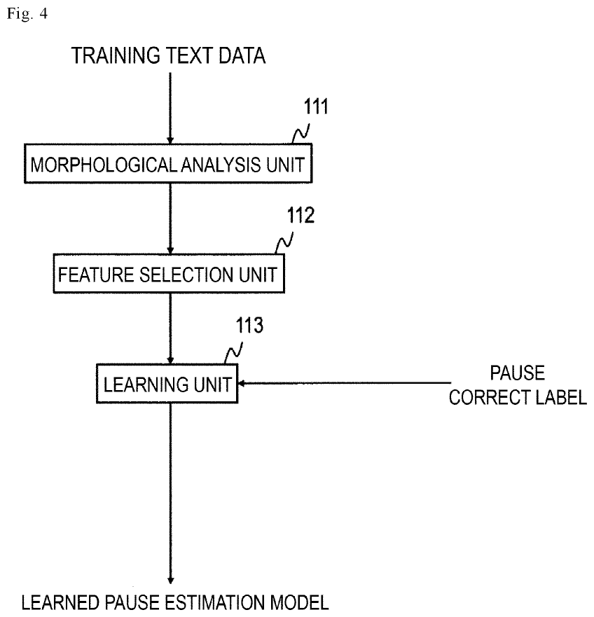

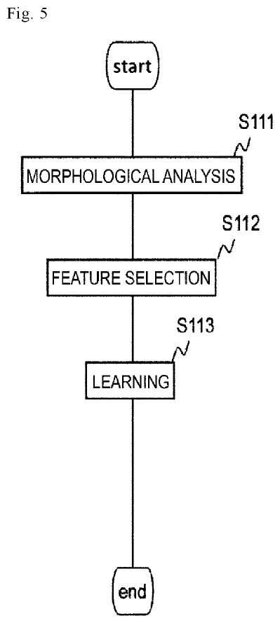

FIG. 4 is a functional block diagram of the pause estimation model learning apparatus according to the present embodiment, and FIG. 5 illustrates an example of the processing flow.

The pause estimation model learning apparatus includes a morphological analysis unit 111, a feature selection unit 112, and a learning unit 113.

The pause estimation model learning apparatus receives training text data and a pause correct label as inputs, learns the pause estimation model, and outputs the learned pause estimation model. Note that the learned pause estimation model is used, for example, in the language processing unit 110 described above.

Note that the training text data is a huge amount of text data used for learning, and the pause correct label is a label indicating a position where a pause is inserted when such text data is read. The correct label may be generated with an appropriate pause position manually provided to the text data or may be generated from a pair of the text data and corresponding spoken voice data. For example, voice recognition processing is executed on the spoken voice data to detect a pause (for example, a section in which the volume continues to be lower than a predetermined threshold for more than a predetermined period of time), and a label indicating the corresponding position in the text data is generated as a pause correct label. Examples of the text data and pause correct label (<P>) are as follows.

### Example: “Maa Kore Wa<P>Jibun Shidai Na Wake De<P>Koko Ni Ka I Te Mo Shikatana I<P>”

The pause estimation model learning apparatus is a special apparatus constituted by, for example, a known or dedicated computer including a central processing unit (CPU), a main storage apparatus (random access memory (RAM)), and the like into which a special program is read. The pause estimation model learning apparatus, for example, executes each processing under control of the central processing unit. The data input to the pause estimation model learning apparatus and the data obtained in each processing, for example, are stored in the main storage apparatus, and the data stored in the main storage apparatus is read out, as needed, to the central processing unit to be used for other processing. At least a portion of each processing unit of the pause estimation model learning apparatus may be constituted with hardware such as an integrated circuit. Each storage unit included in the pause estimation model learning apparatus can be configured, for example, by a main storage device such as a random access memory (RAM) or by middleware such as a relational database or a key-value store. However, each storage unit does not need to be included inside the pause estimation model learning apparatus and may be configured by an auxiliary storage apparatus constituted with a hard disk, an optical disk, or a semiconductor memory element such as a flash memory, and may be provided outside the pause estimation model learning apparatus.

Each unit will be described below.

Morphological Analysis Unit 111 The morphological analysis unit 111 receives the training text data as an input, performs morphological analysis on the training text data (S111), provides M types of information to a morpheme, and outputs the result. Note that M is an integer that is equal to or larger than 2. The result of providing the M types of information to a morpheme is also referred to as a morphological analysis result.

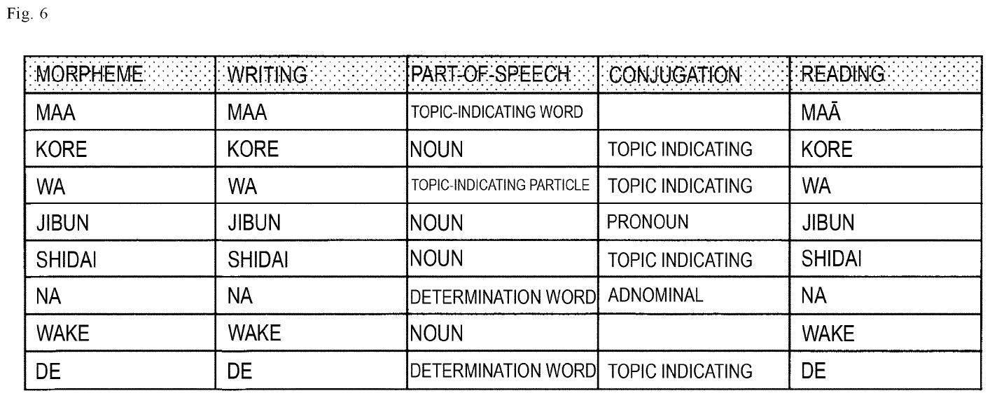

Note that the morphological analysis includes dividing text data into morphemes, which are smallest meaningful units; and providing each of the morphemes with information, such as the part-of-speech or conjugate thereof. This morphological analysis may be performed manually or by using a morphological analyzer. The information (feature) obtained differs depending on the morphological analyzer used. In this example, it is assumed that information such as “writing”, “part-of-speech” “conjugation”, and “reading” is obtainable. Essentially, information to be used as an input feature for the feature selection unit 112 described below may be provided to a morpheme. FIG. 6 shows an example of a configuration in which four types of information “writing”, “part-of-speech”, “conjugation”, and “reading” are given to a morpheme.

Feature Selection Unit 112

The feature selection unit 112 receives the morpheme that has been provided with the M types of information as an input, and outputs an input feature. The input feature is a result of combining N pieces of information among the M pieces of information when a predetermined certain condition is satisfied, or predetermined one of the N pieces of information is selected when the certain condition is not satisfied (S112). Note that N is an integer that is equal to or larger than 2 and equal to or smaller than M. Note that a configuration may be employed in which N is the same as M, and the morphological analysis unit 111 provides the morpheme with only the information used by the feature selection unit 112.

The input feature used for learning is selected from the information (features) obtained by the morphological analysis. In this process, in a related-art method, predetermined types of features have been selected from the features obtained by the morphological analysis, to be directly used as the input features (see FIG. 1). However, such features may include a feature having no impact on the pause estimation process. For example, if the part-of-speech of a morpheme is a noun, replacing the morpheme with “a morpheme with a different writing, the part-of-speech of which is a noun” would almost never lead to a change in the position of the pause. Thus, a combination of features noun+writing has a limited impact on the pause estimation process, and thus can be regarded to be not so important.

In the present embodiment, the features are combined only under a certain condition determined by an administrator of the pause estimation model learning apparatus in advance, to be used as input features, instead of directly using all the features as the input features. With this configuration, the size of the pause estimation model created by machine learning can be reduced from that obtained by the related-art method. Furthermore, the processing speed can be improved. FIG. 2 illustrates an example of a combination between features.

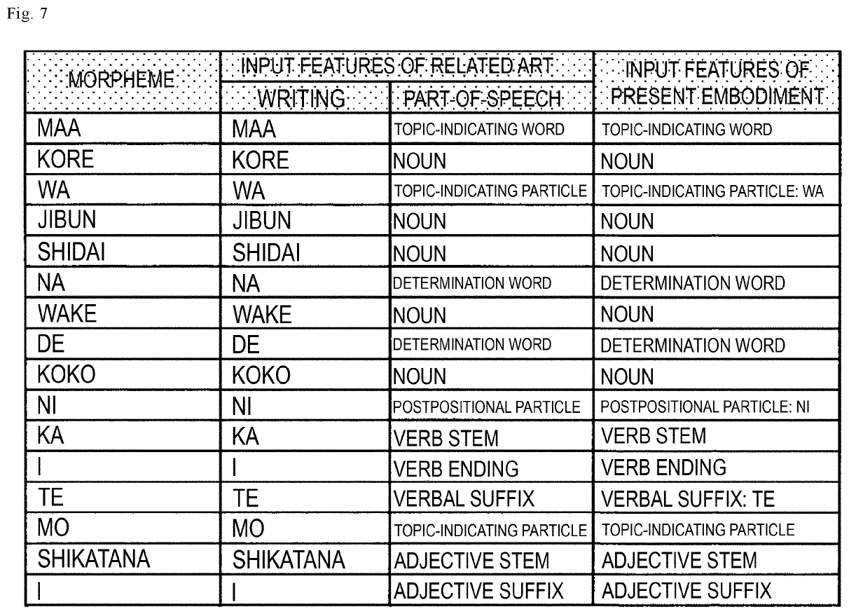

FIG. 7 illustrates an example of a part of the training text data divided into morphemes, input features of related art, and input features of the present embodiment. Note that, for the sake of simplicity, a condition for combining features herein is based on the part-of-speech narrowed down to three of “postpositional particle”, “topic-indicating particle”, and “verbal suffix” that are likely to affect the pause estimation. Specifically, when a part-of-speech of a morpheme is any one of these three, the “part-of-speech” is combined with “writing”, and for a morpheme with a part-of-speech other than these, the part-of-speech is used directly as the input feature.

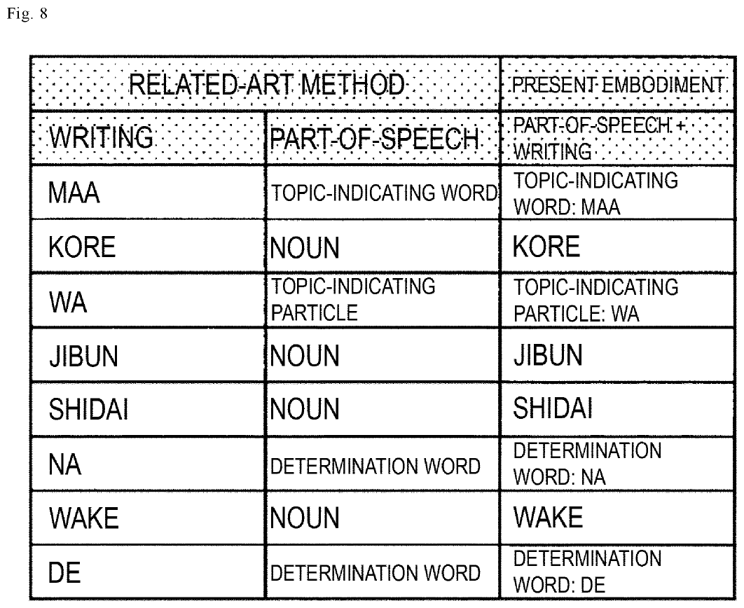

FIGS. 8 to 11 illustrate examples of combinations between features.

In FIG. 8, the condition for combining features is a “part-of-speech” other than a “noun”. Specifically, when the “part-of-speech” of a morpheme is other than a “noun”, the “part-of-speech” and the “writing” are combined. In other cases (when the “part-of-speech” of a morpheme is a “noun”), the “writing” is directly used as the input feature.

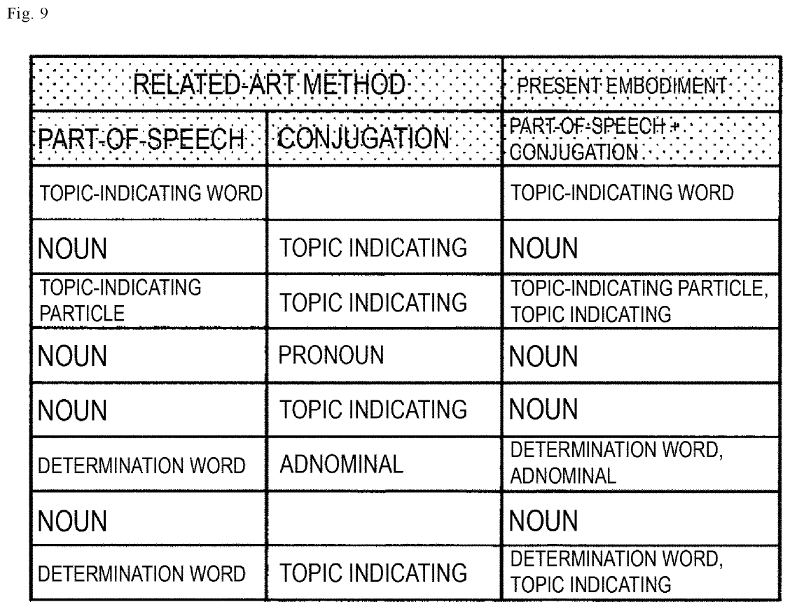

In FIG. 9, the condition for combining features is the same as that in FIG. 8. When the condition is satisfied, the “part-of-speech” and the “conjugation” are combined. When the condition is not satisfied, the “part-of-speech (noun)” is directly uses as the input feature.

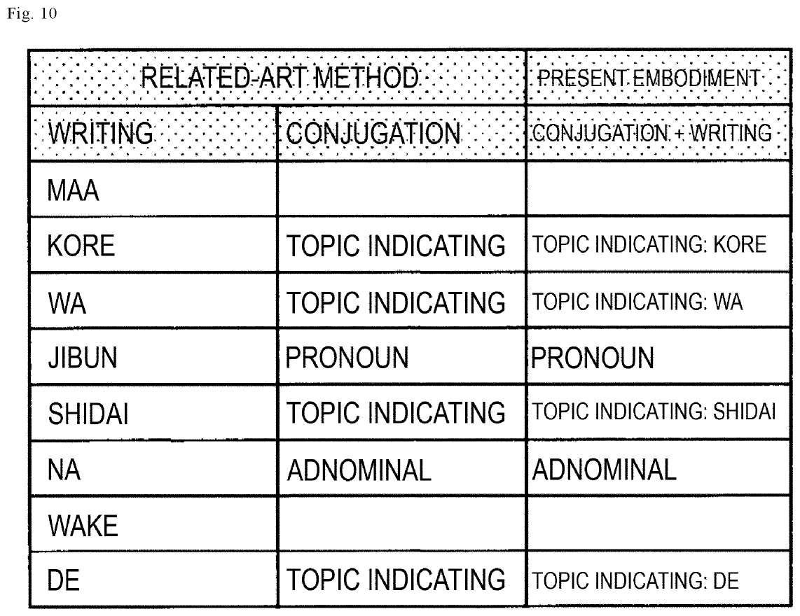

In FIG. 10, the condition for combining features is “conjugation” being “topic indicating”. Specifically, when the “conjugation” of a morpheme is “topic indicating”, the “conjugation” and the “writing” are combined. In other cases, the “conjugation” is directly used as the input feature.

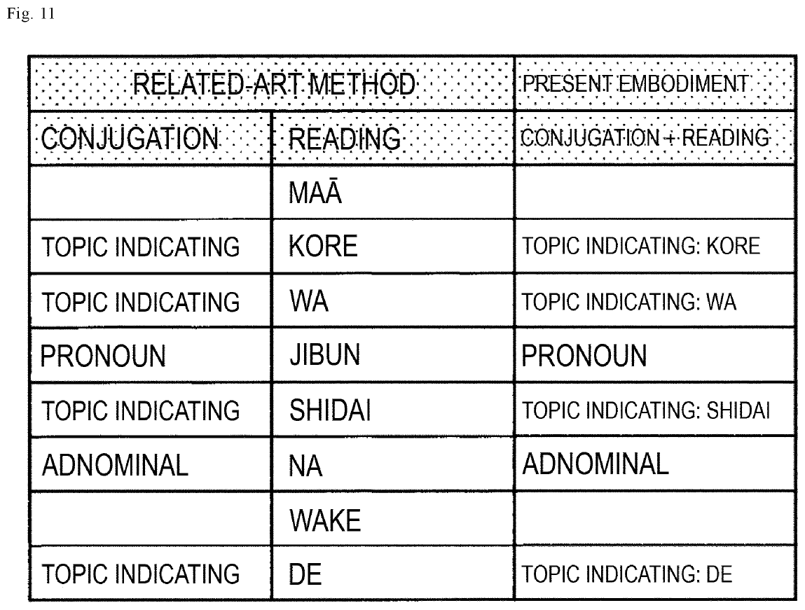

In FIG. 11, the condition for combining features is the same as that in FIG. 10. When the condition is satisfied, the “conjugation” and the “reading” are combined. When the condition is not satisfied, “conjugation” is directly used as the input feature.

Learning Unit 113

The learning unit 113 receives the input feature and the pause correct label as inputs, uses the input feature and the pause correct label to learn the pause estimation model by machine learning (S113), and outputs the learned pause estimation model.

CRF used in NPL 1, the DNN (BLSTM) used in Reference Document 1, or the like can be used for this learning processing. Thus, the learning can be implemented in a procedure that is the same as those in these documents.

(Reference 1) Viacheslav Klimkov, Adam Nadolski, Alexis Moinet, Bartosz Putrycz, Roberto Barra-Chicote, Thomas Merritt, Thomas Drugman, “Phrase break prediction for long-form reading TTS: exploiting text structure information”, INTERSPEECH 2017, pp. 1064 to 1068, 2017

Note that the pause estimation model is a model that uses the input features as inputs and outputs a pause label. Note that the pause label is information indicating the position of the pause in the target text data.

Effects

With the above configuration, with the learned pause estimation model, the model size of the pause estimation model can be reduced from that in the related art, without compromising the estimation accuracy of the pause in the sentence. Furthermore, with the pause estimation model learning apparatus of the present embodiment, the total number of features can be reduced, whereby the learning processing speed can be improved from that with the related-art. Reducing the total number of features also enables the amount of training data to be reduced, whereby a cost for creating the training data can be reduced.

Results of experiment of performing speech synthesis using the learned pause estimation model output from the pause estimation model learning apparatus according to the present embodiment will be described below.

Experiment Details

To demonstrate the effectiveness of the present embodiment, a pause estimation experiment was performed using methods according to the related-art method and according to the present embodiment, and the experimental results were compared.

Data Used for Experiment.

For the experiment, the Japanese text data comprising 5143 sentences and data as a result of manually attaching the correct labels of the pause position to the data were used. Then, morphological analysis was performed manually on this text data, whereby features “writing”, “part-of-speech”, “conjugation” and “reading” were provided. Of the sentences, 3962 sentences were used as training data, and 1181 sentences were used as test data.

Condition of Experiment

Of the features obtained by morphological analysis, “part-of-speech” and “writing” were used as the input features in the related-art method. In the method according to the present embodiment, “part-of-speech” was selected as the input feature, and a feature as a combination of “part-of-speech” and “writing” was used only when the morpheme is “postpositional particle”, “topic-indicating particle”, or “verbal suffix” A pause estimation model was learned using the input feature of each of the above methods, for comparison in accuracy between the methods. CRF was used for the pause estimation model.

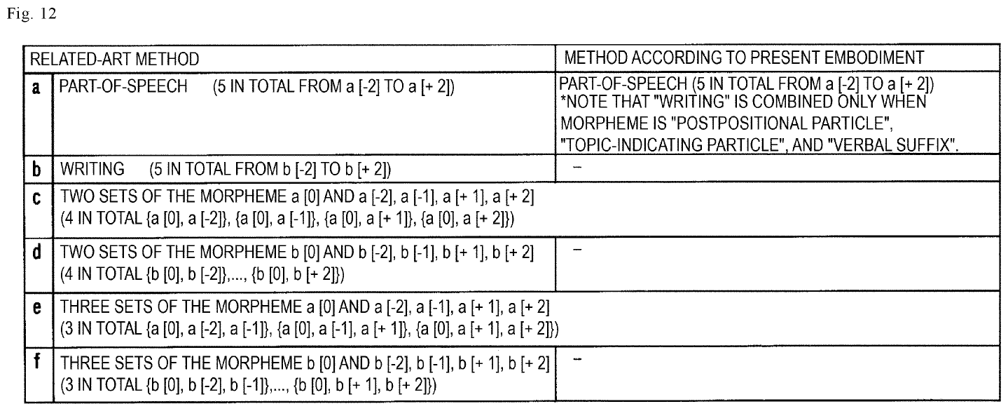

FIG. 12 illustrates features used in CRF. In the experiment, in addition to the feature of a morpheme (hereinafter, denoted by [0]), features of two preceding and two subsequent morpheme (respectively denoted by [−2], [−1], [+1], and [+2]) were also used as the input features for the morpheme.

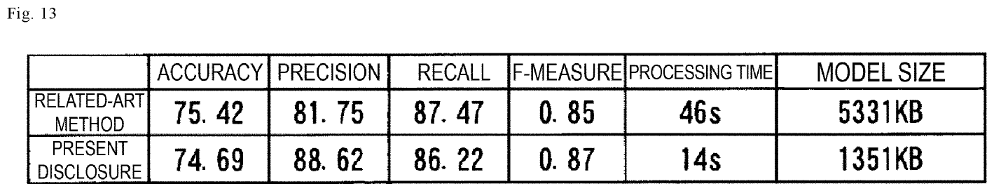

FIG. 13 illustrates sizes of models according to a related-art method and according to the present embodiment, and accuracy of pause estimation relative to the same test data. As can be seen in the table, with the model learned in the method of the present embodiment, the learning processing time and the size were respectively reduced to ⅓ or shorter and ¼ or smaller from those with the related-art method, with the pause estimation accuracy almost not compromised at all.

### Second Embodiment

Parts different from the first embodiment will be mainly described.

In the first embodiment, a case is described where “part-of-speech” is combined with “writing” under a certain condition, as an example of the input feature of the method of the present embodiment. However, as can be seen in FIGS. 2 and 8 to 11, there are a variety of combinations between features, and the input feature that is a combination between “part-of-speech” and “writing” may not necessarily be effective for the pause estimation. In view of this, in the present embodiment, the accuracies of the estimation models learned by the respective input features are compared with each other, and only a model with the most accurate estimation is selected.

In the present embodiment, a feature selection unit combines features, obtained by the morphological analysis, into various combinations to be used as the input features. Here, various conditions for combining features, such as the condition in the first embodiment that is satisfied when “part-of-speech” is “postpositional particle”, “topic-indicating particle”, or “verbal suffix”, are automatically taken into consideration. The learning unit then learns the pause estimation model independently for each input feature, whereby a plurality of pause estimation models are created. The method for learning and the like are the same as those in the first embodiment.

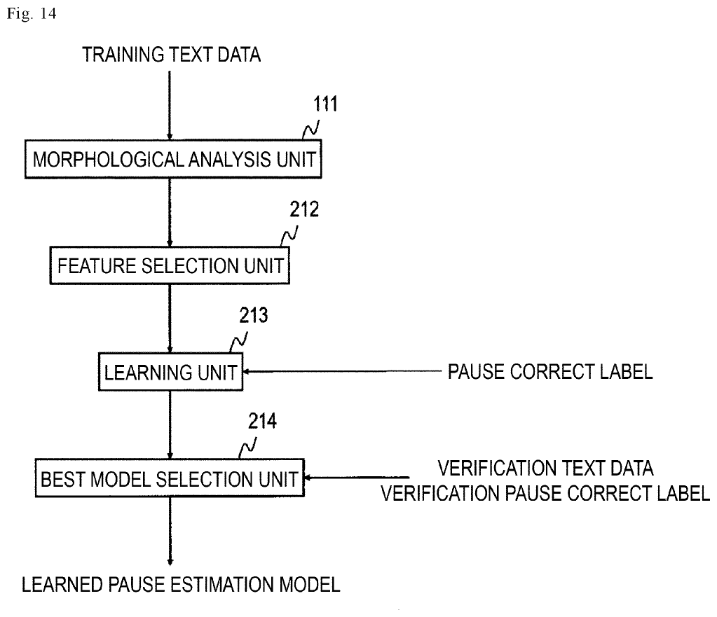

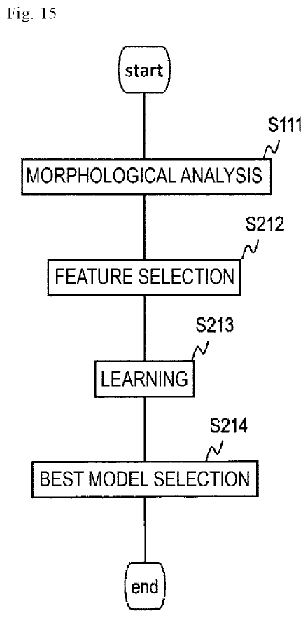

FIG. 14 is a functional block diagram of the pause estimation model learning apparatus according to the second embodiment, and FIG. 15 illustrates an example of the processing flow.

The pause estimation model learning apparatus includes a morphological analysis unit 111, a feature selection unit 212, and a learning unit 213, and a best model selection unit 214.

A difference from the first embodiment is that a plurality of input features are output by the feature selection unit 212, and the best model selection unit 214 selects a model using verification data, after the pause estimation learning using each of the input features.

Feature Selection Unit 212

The feature selection unit 212 receives the morpheme that has been provided with the M types of information as an input, and outputs an input feature. The input feature is an input feature x_{q} as a result of combining N pieces of information among the M pieces of information when a predetermined certain condition is satisfied, or the input feature x_{q} is selected as predetermined one of the N pieces of information when the certain condition is not satisfied (S212). Note that q=1, Q holds, where Q is an integer that is equal to or larger than 2, representing the number of types of combinations. For example, M=4 holds and the information provided to the morpheme includes “writing”, “part-of-speech”, “conjugation”, and “reading”. Furthermore, N=2 and Q=4 hold, with the combinations including “part-of-speech”+“writing”, “conjugation”+“writing”, “part-of-speech”+“conjugation”, and “conjugation”+“reading”. Predetermined certain conditions include (i) “part-of-speech” is not a “noun”, (ii) “conjugation” is “topic indicating”, and the like. FIGS. 8 to 11 illustrate examples of combination. The combination and condition for combining features are as described in the first embodiment.

Learning Unit 213

The learning unit 213 receives Q types of input features x_{q} and the pause correct label as inputs, uses these pieces of information to learn Q pause estimation models (S213) corresponding to the Q types of input features, and outputs the Q learned pause estimation models.

Best Model Selection Unit 214

The best model selection unit 214 receives the Q learned pause estimation models, verification text data, and verification pause correct label as inputs, uses the verification text data and the verification pause correct label to evaluate the Q learned pause estimation models, selects the model most highly evaluated (S214), and outputs the model as the output value of the pause estimation model learning apparatus.

For example, the verification text data is used for comparison between the models learned by the respective input features, in terms of accuracy and size. For example, as described in the section related to the experiment of the first embodiment, the best model is selected for any of the calculated items including an accuracy, precision, recall, F-measure, and model size. Here, the administrator of the pause estimation model learning apparatus designates in advance, a parameter indicating the weight of each item.

Effects

Such configuration can achieve the identical effects as those in the first embodiment. Furthermore, the pause estimation model using the most effective input feature can be output.

### Third Embodiment

In the present embodiment, a pause estimation apparatus for estimating a pause using the pause estimation model learned in the first embodiment and the second embodiment will be described. The pause estimation apparatus is, for example, incorporated in the language processing unit 110 in FIG. 3.

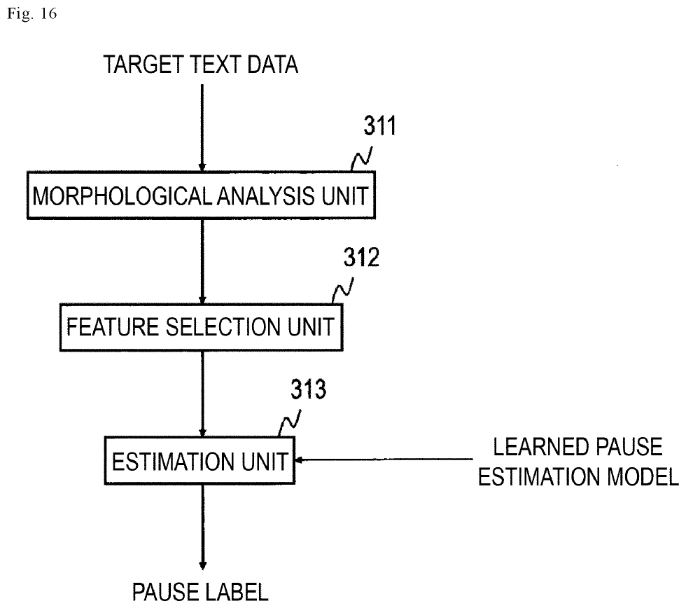

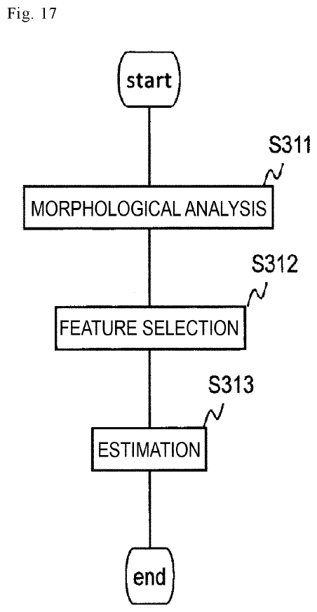

FIG. 16 is a functional block diagram of the pause estimation apparatus according to the present embodiment, and FIG. 17 illustrates an example of the processing flow.

The pause estimation apparatus includes a morphological analysis unit 311, a feature selection unit 312, and an estimation unit 313.

The pause estimation apparatus receives the text data of interest (hereinafter, also referred to as “target text data”) as an input, estimates the position of the pause, and outputs the estimated position as a pause label.

Processes S311 and S312 executed by the morphological analysis unit 311 and the feature selection unit 312 are similar to the processes S111 and S112 executed by the morphological analysis unit 111 and the feature selection unit 112 of the first embodiment. However, the processes are executed with the target text data and information obtained from the target text data input, instead of the training text data and the information obtained from the training text data.

Next, details of the processing executed by the estimation unit 313 will be described.

Estimation unit 313

The estimation unit 313 receives the learned pause estimation model before executing the estimation processing.

The estimation unit 313 receives the input feature as an input, estimates the position of the pause using the pause estimation model (S313), and outputs the position as a pause label. As described in the first embodiment and the second embodiment, the input feature is a combination of N pieces of information, among M pieces of information, when a predetermined certain condition is satisfied, and the input feature is predetermined one of the N pieces of information when the certain condition is not satisfied.

Effects

With a pause estimation model of a model size smaller than that in the related art, the estimation accuracy for a pause in a sentence can be maintained.

Other Modifications

The present disclosure is not limited to the above embodiments and modifications. For example, the various processes described above may be executed not only in chronological order as described but also in parallel or on an individual basis as necessary or depending on the processing capabilities of the apparatuses that execute the processing. In addition, appropriate changes can be made without departing from the spirit of the present disclosure.

Program and Recording Medium

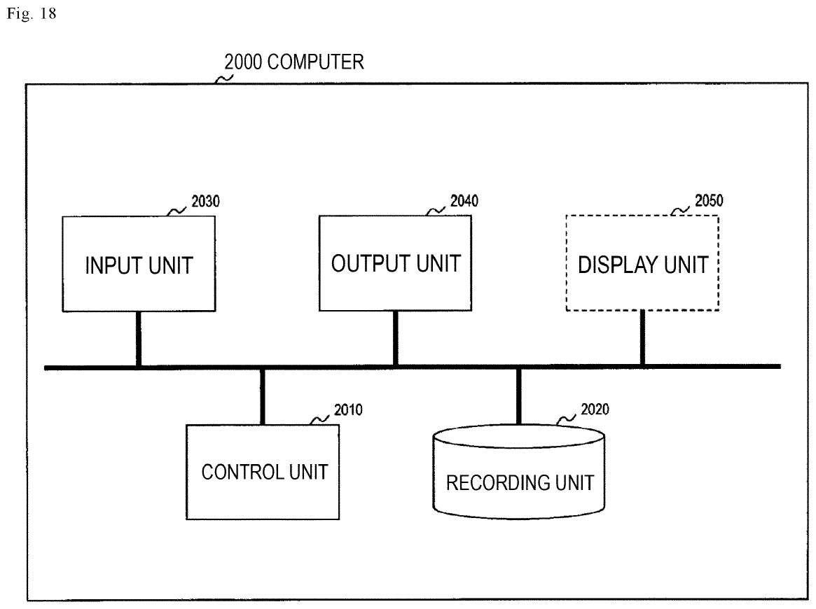

The various types of processing described above can be performed by causing a recording unit 2020 of the computer illustrated in FIG. 18 to read a program for executing each of steps of the above method and causing a control unit 2010, an input unit 2030, an output unit 2040, and the like to execute the program.

The program in which the processing details are described can be recorded on a computer-readable recording medium. The computer-readable recording medium, for example, may be any type of medium such as a magnetic recording device, an optical disc, a magneto-optical recording medium, or a semiconductor memory.

In addition, the program is distributed, for example, by selling, transferring, or lending a portable recording medium such as a DVD or a CD-ROM with the program recorded on it. Further, the program may be stored in a storage device of a server computer and transmitted from the server computer to another computer via a network, so that the program is distributed.

For example, a computer executing the program first temporarily stores the program recorded on the portable recording medium or the program transmitted from the server computer in its own storage device. When the computer executes the processing, the computer reads the program stored in the recording medium of the computer and executes a process according to the read program. As another execution form of the program, the computer may directly read the program from the portable recording medium and execute processing in accordance with the program. Further, each time the program is transmitted from the server computer to the computer, the computer executes processing in order in accordance with the received program. In another configuration, the processing may be executed through a so-called application service provider (ASP) service in which functions of the processing are implemented just by issuing an instruction to execute the program and obtaining results without transmission of the program from the server computer to the computer. Further, the program in this mode is assumed to include information which is provided for processing of a computer and is equivalent to a program (data or the like that has characteristics of regulating processing of the computer rather than being a direct instruction to the computer).

In addition, although the device is configured by executing a predetermined program on a computer in this mode, at least a part of the processing details may be implemented by hardware.

1. A pause estimation model learning apparatus comprising a processor configured to execute a method comprising:
performing morphological analysis on training text data to provide M types of information, M being an integer that is equal to or larger than 2;
combining N pieces of information, among the M pieces of information, to be an input feature when a predetermined condition is satisfied;
selecting predetermined one of the N pieces of information to be the input feature when the predetermined condition is not satisfied, N being an integer that is equal to or larger than 2 and equal to or smaller than M; and
learning a pause estimation model by using the input feature and a pause correct label including a pause position.

2. The pause estimation model learning apparatus according to claim 1, wherein
the performing further includes providing information “writing” and information “part-of-speech”, and
the combining combines the information “writing” and the information “part-of-speech” when “part-of-speech” provided to a morpheme is any one of “postpositional particle”, “topic-indicating particle”, and “verbal suffix”, to be the input feature, and selects the information “part-of-speech” as the input feature when “part-of-speech” provided to a morpheme is none of “postpositional particle”, “topic-indicating particle”, and “verbal suffix”, where N=2 holds.

3. The pause estimation model learning apparatus according to claim 1, wherein
the combining combines N pieces of information, among the M pieces of information, to be an input feature xq when the predetermined certain condition is satisfied, and selects predetermined one of the N pieces of information as an input feature xq when the predetermined condition is not satisfied, where q=1, Q holds, Q being an integer that is equal to or larger than 2,
the learning learns Q pieces of pause estimation models by using Q types of input features xq and a pause correct label, and
the processor further configured to execute a method comprising: comprises
evaluating the Q pieces of pause estimation models by using a verification text data and a verification pause correct label; and
selecting a model that is most highly evaluated.

4. A pause estimation apparatus comprising a processor configured to execute a method for estimating a pause position in text data by using the pause estimation model comprising:
performing morphological analysis on the text data, to provide M types of information;
combining N pieces of information, among the M pieces of information, to be an input feature when a predetermined condition is satisfied, and select predetermined one of the N pieces of information to be the input feature when the predetermined condition is not satisfied;
receiving the input feature; and
estimating the pause position, by using the pause estimation model.

5. A pause estimation model learning method comprising:
performing morphological analysis on training text data to provide M types of information, M being an integer that is equal to or larger than 2;
combining N pieces of information, among the M pieces of information, to be an input feature when a predetermined condition is satisfied, and selecting predetermined one of the N pieces of information to be the input feature when the predetermined condition is not satisfied, N being an integer that is equal to or larger than 2 and equal to or smaller than M; and
learning a pause estimation model by using the input feature and a pause correct label including a pause position.

6-7. (canceled)

8. The pause estimation model learning apparatus according to claim 1, wherein the pause position corresponds to a position for putting an intermission in synthesizing speech.

9. The pause estimation model learning apparatus according to claim 1, wherein the pause estimation model estimates a timing of putting an intermission for implementing speech synthesis.

10. The pause estimation model learning apparatus according to claim 1, wherein the pause estimation model receives the input features as input and outputs a pause label.

11. The pause estimation model learning apparatus according to claim 3, wherein the evaluating is based at least one of an accuracy of estimation or a model size.

12. The pause estimation apparatus according to claim 4, wherein
the performing further includes providing information “writing” and information “part-of-speech”, and
the combining combines the information “writing” and the information “part-of-speech” when “part-of-speech” provided to a morpheme is any one of “postpositional particle”, “topic-indicating particle”, and “verbal suffix”, to be the input feature, and selects the information “part-of-speech” as the input feature when “part-of-speech” provided to a morpheme is none of “postpositional particle”, “topic-indicating particle”, and “verbal suffix”, where N=2 holds.

13. The pause estimation apparatus according to claim 4, wherein
the combining combines N pieces of information, among the M pieces of information, to be an input feature xq when the predetermined condition is satisfied, and selects predetermined one of the N pieces of information as an input feature xq when the predetermined condition is not satisfied, where q=1,2, . . . , Q holds, Q being an integer that is equal to or larger than 2,
the learning learns Q pieces of pause estimation models by using Q types of input features xq and a pause correct label, and
the processor further configured to execute a method comprising:
evaluating the Q pieces of pause estimation models by using a verification text data and a verification pause correct label; and
selecting a model that is most highly evaluated.

14. The pause estimation apparatus according to claim 4, wherein the pause position corresponds to a position for putting an intermission in synthesizing speech.

15. The pause estimation apparatus according to claim 4, wherein the pause estimation model estimates a timing of putting an intermission for implementing speech synthesis.

16. The pause estimation apparatus according to claim 4, wherein the pause estimation model receives the input features as input and outputs a pause label.

17. The pause estimation apparatus according to claim 13, wherein the evaluating is based at least one of an accuracy of estimation or a model size.

18. The pause estimation model learning method according to claim 5, wherein
the performing further includes providing information “writing” and information “part-of-speech”, and
the combining combines the information “writing” and the information “part-of-speech” when “part-of-speech” provided to a morpheme is any one of “postpositional particle”, “topic-indicating particle”, and “verbal suffix”, to be the input feature, and selects the information “part-of-speech” as the input feature when “part-of-speech” provided to a morpheme is none of “postpositional particle”, “topic-indicating particle”, and “verbal suffix”, where N=2 holds.

19. The pause estimation model learning method according to claim 5, wherein
the combining combines N pieces of information, among the M pieces of information, to be an input feature xq when the predetermined condition is satisfied, and selects predetermined one of the N pieces of information as an input feature xq when the predetermined condition is not satisfied, where q=1,2, . . . , Q holds, Q being an integer that is equal to or larger than 2,
the learning learns Q pieces of pause estimation models by using Q types of input features xq and a pause correct label, and
the method further comprising:
evaluating the Q pieces of pause estimation models by using a verification text data and a verification pause correct label; and
selecting a model that is most highly evaluated.

20. The pause estimation model learning method according to claim 5, wherein the pause position corresponds to a position for putting an intermission in synthesizing speech.

21. The pause estimation model learning method according to claim 5, wherein the pause estimation model estimates a timing of putting an intermission for implementing speech synthesis.

22. The pause estimation model learning method according to claim 5, wherein the pause estimation model receives the input features as input and outputs a pause label.
